(19) United States
(12) Patent Application Publication
(10) Pub. No.: US 2025/0335445 A1
(43) Pub. Date: Oct. 30, 2025

(54) INFORMATION QUERY SYSTEM AND INFORMATION QUERY METHOD

(71) Applicant: InnoLux Corporation, Miao-Li County (TW)

(72) Inventor: Chao-Hsuan KO, Miao-Li County (TW)

(73) Assignee: InnoLux Corporation, Miao-Li County (TW)

(21) Appl. No.: 19/093,243

(22) Filed: Mar. 27, 2025

(30) Foreign Application Priority Data
Apr. 24, 2024 (CN) 202410496265.9

(51) Int. Cl. G06F 16/2455; G06F 16/248

(52) U.S. Cl. CPC G06F 16/24553; G06F 16/248

(57) ABSTRACT

An information query system includes a receiving unit, a computing unit, and an output unit. The receiving unit is used to receive a query request, and the query request has a query value. The computing unit is used to select a plurality of data strings that match the query value from historical data. The plurality of data strings each have a first feature value and a second feature value. The first feature value is related to the query value. The output unit is used to output at least one second feature value and a proportion of the at least one second feature value.

### BACKGROUND OF THE DISCLOSURE

### 1. Field of the Disclosure

The present disclosure is related to an information query system and information query method, and more particularly, to an information query system and information query method that may receive query request and output feature values and proportion accordingly.

### 2. Description of the Prior Art

In the field of knowledge accumulation and sharing, the accumulation and transfer of practical experience and knowledge are important, but also difficult. For example, on a production line of a high-tech factory, when a machine displays an error code or makes an abnormal sound, it is often necessary to ask senior personnel to confirm the problem and handle it. However, senior personnel may not always be accessible, and knowledge may even be lost when senior personnel leave. Therefore, managers often require senior personnel to record the problem-solving process and related knowledge into documents and retain them so other personnel may easily review and/or learn from them. However, over time, the number of documents written by senior personnel increased, and the large number of documents caused difficulty in searching. Besides, documents written by different people may have different formats, problem description methods, and completeness of content, which also makes it difficult to search. Therefore, even if a knowledge search is required, it may not be possible to find a suitable answer from a large number of documents, or it may take a long time to find a suitable answer. There is still a lack of suitable solutions in this field to deal with the above problems.

### SUMMARY OF THE DISCLOSURE

An embodiment provides an information query system. The information query system includes a receiving unit, a computing unit, and an output unit. The receiving unit is used to receive a query request, and the query request has a query value. The computing unit is used to select a plurality of data strings that match the query value from historical data. The plurality of data strings each have a first feature value and a second feature value. The first feature value is related to the query value. The output unit is used to output at least one second feature value and a proportion of the at least one second feature value.

Another embodiment provides an information query method used in an information query system. The information query system includes a receiving unit, a computing unit, and an output unit. The information query method includes the following steps. The receiving unit receives a query request and the query request has a query value. The computing unit selects a plurality of data strings that match the query value from historical data, the plurality of data strings each includes a first feature value and a second feature value, the first feature value is related to the query value. The computing unit generates at least one proportion according to at least one first feature value and at least one second feature value and the plurality of data strings. The output unit outputs the at least one proportion, and the at least one second feature value corresponding to the at least one proportion.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a diagram of an information query system according to an embodiment of the present disclosure.

FIG. 2 is a schematic diagram of the steps for querying using the information query system in FIG. 1.

FIG. 3 is a visual schematic diagram of the second feature value and the corresponding proportion output by the information query system in FIG. 1 according to an embodiment of the present disclosure.

FIG. 4 is a visual schematic diagram of the second feature value and the corresponding proportion output by the information query system in FIG. 1 according to another embodiment of the present disclosure.

FIG. 5 is a flow chart of an information query method used in the information query system of FIG. 1.

### DETAILED DESCRIPTION

The present disclosure may be described as follows.

To explain the disclosure, various specific details and embodiments may be mentioned herein to make the disclosure understandable. The specific elements and arrangements mentioned herein are used to clearly describe the disclosure. However, the exemplary embodiments herein are only used to illustrate the present disclosure, and the concept of the present disclosure may be embodied into various reasonable embodiments and are not limited to the exemplary embodiments herein. Furthermore, similar and/or corresponding reference numerals may be used in the drawings of different embodiments to indicate similar and/or corresponding elements to clearly describe the present disclosure. However, the use of similar and/or corresponding reference numerals in the drawings of different embodiments does not indicate a correlation between the embodiments.

Certain terms are used throughout the description and the following claims to refer to specific elements. As those skilled in the art will understand, electronic device manufacturers may refer to components by different names. This document does not intend to differentiate between components that have different names rather than different functions. In the following description and in the scope of the claims, the terms “comprising”, “including” and “having” are used in an open-ended manner and should therefore be interpreted to mean “including but not limited to . . . ” Accordingly, when the terms “comprising”, “including” and/or “having” are used in the description of the present disclosure, it may indicate the presence of corresponding features, regions, steps, operations and/or elements, but is not limited to the presence of one or more corresponding features, regions, steps, operations and/or components.

It should be understood that, although the terms first, second, third, etc. may be used herein to describe various elements, components, regions, layers, and/or sections, these elements, components, regions, layers, and/or sections shall not be limited by these terms. These terms are only used to distinguish one element, component, region, layer or section from another element, component, region, layer or section. Therefore, a first element, components, region, layer or section discussed below could be termed a second element, components, region, layer or section without departing from the teachings of the present disclosure.

It should be understood that, herein, the description of the exemplary embodiments is intended to be read with the accompanying drawings, which may be considered a part of the entire written description. The drawings are not drawn to scale. Furthermore, in order to simplify the drawings, structures and devices are schematically illustrated.

Unless otherwise defined, all technical and scientific terms used herein may have the same meaning as commonly understood by one of ordinary skill in the art. It should be understood that, unless otherwise defined, in each case, terms defined in commonly used dictionaries may be interpreted to have meanings consistent with the relevant techniques of the disclosure and the background or context of the disclosure, and should not be interpreted in an idealistic or overly formal manner.

In this document, when a plurality of items are mentioned, if they are connected by “and/or”, it means each of the items and any combination of the items. For example, when referring to “A, B, and/or C”, this may be any of “A”, “B”, “C”, “A and B”, “A and C”, “B and C”, and “A, B and C”.

Furthermore, in some embodiments of the present disclosure, unless otherwise defined, terms such as “connected”, “interconnected” and “coupled” refer to the relationship in which structures are directly or indirectly fixed or connected to each other through intermediate structures or elements, as well as movable or rigid attachments or relationship.

The electronic device of the present disclosure may include a display device, an antenna device, a sensing device, a light-emitting device, a touch display, a curved display or a free shape display, but is not limited thereto. The electronic device may include a bendable or flexible electronic device. Electronic devices may include, for example, electronic components, liquid crystals, light emitting diodes, quantum dots (QDs), fluorescence, phosphor, other suitable display media, or combinations of the above materials, but is not limited thereto. Electronic components may include passive components and active components, such as capacitors, resistors, inductors, diodes, transistors, etc. Diodes may include light emitting diodes or photodiodes. The light emitting diodes may include, for example, organic light emitting diodes (OLEDs), mini LEDs, micro LEDs or quantum dot LED (may include QLED, QDLED), other suitable material, or combinations of the above materials, but is not limited thereto. The display device may, for example, include a spliced display device, but is not limited thereto. The antenna device may be, for example, a liquid crystal antenna, but is not limited thereto. The antenna device may, for example, include an antenna splicing device, but is not limited thereto. It should be noted that the electronic device may be any combination of the above, but is not limited thereto. Furthermore, the shape of the electronic device may be a rectangular shape, a circular shape, a polygonal shape, a shape with curved edges, or other suitable shapes. The electronic device may have peripheral systems such as a driving system, a control system, a light source system, etc. to support the display device, antenna device or splicing device, but the present disclosure is not limited thereto. The sensing device may include a camera, an infrared sensor, a fingerprint sensor, etc., but the disclosure is not limited thereto. In some embodiments, the sensing device may also include a flash lamp, an infrared (IR) light source, other sensors, electronic components, or a combination thereof, but is not limited thereto.

It should be noted that technical features in different embodiments described below may be replaced, recombined, or mixed with each other to constitute another embodiment without departing from the spirit of the present disclosure.

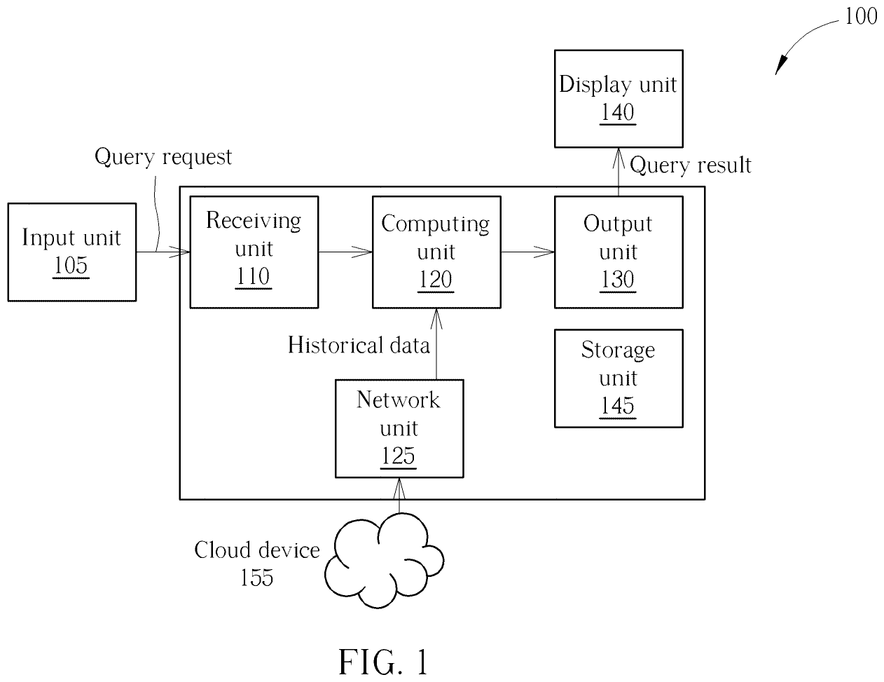

FIG. 1 is a diagram of an information query system 100 according to an embodiment of the present disclosure. The information query system 100 may include a receiving unit 110, a computing unit 120, and an output unit 130. The receiving unit 110 may be configured to receive a query request Qin, the query request Qin may have a query value. The computing unit 120 may be configured to select a plurality of data strings that match the query value of the query request Qin from the historical data H. The plurality of data strings may each include a first feature value and a second feature value. The computing unit 120 may select a plurality of data strings that match the query value of the query request Qin through the information retrieval language model method. The query request Qin may include a text string to describe the query problem. For example, a user may enter a text string to describe the problem encountered by a machine or factory during production, such as an error code of the machine, or describe abnormal sounds emitted by the machine in natural language, etc., but is not limited thereto. The query value may include numbers, text, words, etc. or a combination of the above, but is not limited thereto. The historical data may include a plurality of data strings. Each data string may be a file or a text string in the historical data H, which is used to describe a problem that has occurred on a certain machine or factory during the production of electronic devices, the abnormal behavior of the machine when the problem occurred, and the methods and/or steps to solve the problem, but is not limited thereto. Each data string may include a first feature value and a second feature value, and the first feature value and the second feature value may include a text string. For example, the first feature value may be a text string describing a problem, and the second feature value may be a text string describing a cause of the problem or a text string describing a method or step for solving the problem. For example, the first feature value may be a problem encountered by a machine or a factory on a production line, which may be a defect symptom found by a user in the production process. The second feature value may be a real root cause corresponding to the problem described in the historical data H. The output unit 130 may be configured to output the query result R, and the query result R may include at least a second feature value and a proportion of the second feature value.

For example, users may enter anomalies in engineering problems through query request Qin. For example, users can use query request Qin to raise issues regarding V-line abnormalities that occur when manufacturing display panels. Then, the computing unit 120 may compare and/or retrieve the first feature value in the historical data H according to the keyword (for example, V-line). When the correlation between the first feature value and the query request Qin is high, it means that the first feature value is related to the query value of the query request Qin, and at least one second feature value and the corresponding proportion in the data string that matches the query request Qin may be returned in a short period of time (for example, within 10 seconds, but not limited thereto). For example, the output unit 130 may output three real root causes and proportions corresponding to the V-line abnormality problem, which may be 35% for electrostatic discharge (ESD), 40% for thin film transistor (TFT) defects, and 25% for source chip bonding defects. The proportions corresponding to the above multiple real root causes may be added to 100%. Therefore, after users input engineering problems through query request Qin, they may quickly obtain multiple real root causes and corresponding proportions, which helps prompt users to speed up debugging. For example, when engineering problems occurred in the past, it usually took weeks, sometimes even months, to find the root causes and make prevention and improvement accordingly. However, by using the information query system 100, the accumulated experience in the historical data H may be effectively used to shorten the debugging process to a few days, a day, or even a few minutes to find possible real root causes for prevention and/or improvement.

According to an embodiment, the second feature value and the corresponding proportion may be a quotient of the first value and the second value, which may be calculated according to conditional probability. The first value divided by the second value may be expressed as P (real root cause|defect symptom)=P (defect symptom & real root cause)/P (defect symptom). The first value (P (defect symptom & real root cause) in the above text) may correspond to the maximum number of data strings in the historical data H having the first feature value and having a same second feature value. The second value (P (defect symptom) in the above text) may correspond to the number of data strings comprising the first feature value in the historical data H. This may output the most likely second feature value (e.g., the “real root cause” of the problem). For example, the most likely “real root cause” may be provided to help users debug errors.

According to another embodiment, the second feature value and the corresponding proportion may be a quotient of the first value and the second value, which may be calculated according to conditional probability. The first value divided by the second value may be expressed as P (real root cause|defect symptom)=P (defect symptom & real root cause)/P (defect symptom). The first value (P (defect symptom & real root cause) in the above text) may respectively correspond to the number of data strings in the plurality of data strings corresponding to the first feature value contained in the historical data H having different second feature values. The second value (P (defect symptom) in the above text) may correspond to the number of data strings comprising the first feature value in the historical data H. In this way, all possible second feature values (for example, the “real root causes” of the problem) and the corresponding proportions may be output. For example, multiple “real root causes” and corresponding proportions may be provided to help users debug errors.

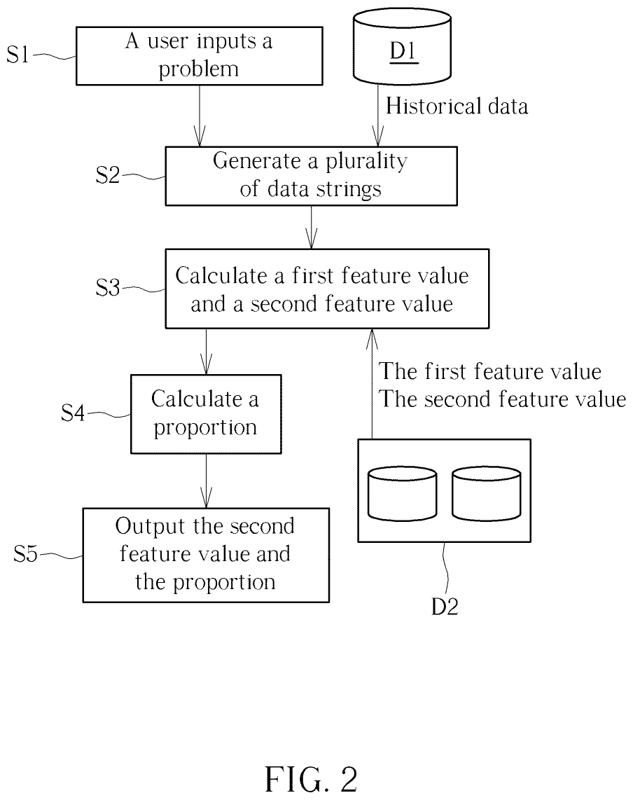

Regarding the calculations mentioned here and how to generate the proportion, examples will be provided later in the description of FIG. 2 and how to perform detailed calculations step by step.

Optionally, as shown in FIG. 1, the receiving unit 110 may receive the query request Qin input by the user through the input unit 105. For example, the input unit 105 may include a microphone, a keyboard, a writing pad, a selection button, etc., but the present disclosure is not limited thereto. The display unit 140 may receive the query result R to display the above-mentioned second feature values and their proportions, such as the above-mentioned “35% for electrostatic discharge (ESD), 40% for thin film transistor (TFT) defects, and 25% for source chip bonding defects” and other problems and the corresponding proportions. For example, the display unit 140 may include a display, related control circuitry, software, and/or hardware, but the present disclosure is not limited thereto. The display unit 140 may include a general display, an OLED display, a micro LED display, a flexible display, etc., and the present disclosure is not limited thereto. In some embodiment, the information query system 100 may further include a network unit 125 and/or a storage unit 145. The historical data H may be stored in the cloud device 155, and the computing unit 120 may receive the historical data H from the cloud device 155 through the network unit 125. For example, the network unit 125 may include a network interface, a network modem, and/or a network interface card, but the present disclosure is not limited thereto. Optionally, the historical data H may be stored in the cloud device 155. For example, the cloud device 155 may be a cloud hard drive located in the cloud, and the path between the cloud device 155 and the network unit 125 may include a wired path and/or a wireless path. During the computing and data processing process of the information query system 100, all data may be stored in the storage unit 145 for access. The storage unit 145 may include buffer memory, main memory, dynamic random access memory (DRAM), and/or static random access memory (SRAM), the disclosure is not limited thereto.

FIG. 2 is a schematic diagram of the steps for querying using the information query system 100 in FIG. 1. In Step S1 of FIG. 2, the user may describe the problem encountered and input it into the information query system 100 through the query request Qin.

In Step S2, similar data may be found in the historical data H according to the query value of the query request Qin to generate a plurality of data strings. The historical data H may include past experiences and/or cases, and may be provided by the database D1.

In Step S3, a second value corresponding to the first feature value and a first value corresponding to both the first feature value and the second feature value may be calculated. For example, a first feature value may include a “defect symptom” in a user-entered problem, and a second feature value may include a “real root cause” corresponding to the defect symptom. The first feature value and the second feature value may be provided by the database D2. Database D1 and database D2 may be set up in the cloud device 155 and/or the storage unit 145 in FIG. 1 at the same time, or respectively set up in the cloud device 155 and/or the storage unit 145 in FIG. 1, the present disclosure is not limited thereto.

In Step S4, a conditional probability operation may be performed according to the first value and the second value to generate a proportion corresponding to the second feature value (for example, the “real root cause” of the problem).

In Step S5, at least one second feature value and the corresponding proportion may be output.

For example, as shown in FIG. 1 and FIG. 2, in step S1, the user may input the “V-line” keyword as the query request Qin. In Step S2, the computing unit 120 may select a plurality of data strings that match the query value of the query request Qin through the best matching method. For example, the best matching method may include the Okapi BM25 algorithm (also known as the BM25 algorithm), Keyword Search algorithm, Embedding Search algorithm, and/or Ensemble Search algorithm, etc.

For example, in Step S2, when the user inputs “V-line”, the BM25 algorithm may be used to find 20 documents (that is, 20 data strings) in the historical data H.

In Step S3, according to the plurality of first feature values (for example, “defect symptoms”) and the plurality of second feature values (for example, the “real root causes” of the problem) in the database D2, it may be obtained that among the 20 data strings obtained in Step S2, 10 contain the first feature value corresponding to the query request Qin, and 3 articles contain both the first feature value and the second feature value corresponding to the query request Qin. In this example, the following first value and second value may be obtained:

$$P ( defect symptom ) = 10 / 20 = 0.5 ;$$

$$P ( defect symptom \& real root cause ) = 3 / 20 = 0 \text{.15} ;$$

The second value is P (defect symptom), and the first value is P (defect symptom & real root cause). In Step S4, conditional probability calculation can be performed, and may be expressed as follows:

$$P ( real root cause \vert defect Symptom ) = P ( defect symptom \& real root cause ) / P ( defect symptom ) ;$$

In the above example, P (real root cause|defect Symptom)=P (defect Symptom & real root cause)/P (defect symptom)=0.15/0.5=30%. P (real root cause|defect Symptom) here may be the proportion mentioned above. In Step S5, the corresponding second feature value (for example, the “real root cause” of the problem) and the proportion may be output. For example, if the second feature value here is “source chip bonding defect” and the corresponding proportion is “30%”, the user can see in Step S5 that the result of “source chip bonding defect 30%” is displayed on the display unit 140 in FIG. 1. Therefore, it may prompt the user to the real root cause of the problem and help the user to debug.

Regarding information retrieval, the Okapi BM25 (Best Matching 25, BM25) algorithm mentioned above can be an improved version based on the Okapi TF-IDF algorithm. The BM25 algorithm may be used to estimate the correlation between a document (hereinafter referred to as d) and a user query (hereinafter referred to as Q, which can correspond to the query request Qin in FIG. 1 of this case), and is more suitable when processing long documents and short queries. The document d may correspond to historical data H in FIG. 1. BM25 may calculate the correlation between the document d and the user query Q based on term frequency (TF) and inverse document frequency (IDF), and may also consider the length of the document.

The BM25 score may be expressed as

$$Score ( D , Q ) = {\sum }_{i}^{n} Wi R ( qi , d ) .$$

qi may be the i-th word in the query, Wi may be the weight of the word qi, and R (qi,d) may be the correlation score between the word qi and the document d. The weight Wi may be used to determine the weight of the correlation between the word and the document. For example, the IDF algorithm may be used,

$$I D F ( qi ) = log \frac{N - n ( qi ) + 0.5}{n ( qi ) + 0.5} ,$$

N may be the number of all documents, and n(qi) may be the number of documents including word qi.

The keyword search algorithm mentioned above may use the BM25 algorithm to select relevant documents, and is more effective for keywords in specific fields, such as personal names, structural names, etc. The embedding search algorithm may use the embedding model to embed the query and corpus into text, and use vector similarity for text matching. The embedding search algorithm may deal with the shortcomings of the BM25 algorithm in recalling similar keywords. The embedding search algorithm may use, for example, a vector database. The ensemble search algorithm may combine the results of the BM25 algorithm and the embedded search, and use the reordering algorithm for final sorting, which may be better than the separate recall algorithm.

In other embodiments, the relevant data string may be found through Language Model for Information Retrieval (LMIR), but the present disclosure is not limited thereto. Language Model for Information Retrieval (LMIR) may use language models to calculate relevance scores between documents and queries. The most common formula may be to use KL (Kullback-Leibler) divergence to measure the similarity between documents and queries. Here is the KL divergence formula used in LMIR:

Suppose there is a query Q and a document D, and w is the word in the document. They are expressed as probability distributions of words P(w|Q) and P(w|D) respectively. The relevance score between the document D and the query Q may be calculated using KL divergence:

$$Score ( Q \vert D ) = {\sum }_{w ∈ Q} P ( w \vert Q ) log \frac{P ( w \vert Q )}{P ( w \vert D )}$$

P(w|Q) may represent the probability of word w in query Q, and P(w|D) may represent the probability of word w in document D. The meaning of this formula is that for each word w in the query, calculate the logarithm of the ratio of its probability in the query to its probability in the document, and then sum it up as the relevance score.

An interpretation of the above formula is that it measures the difference between the words in the query and the words in the document, thereby assessing the relevance between the document and the query. Documents may be ranked according to the calculated relevance scores, so that the most relevant documents are provided as search results.

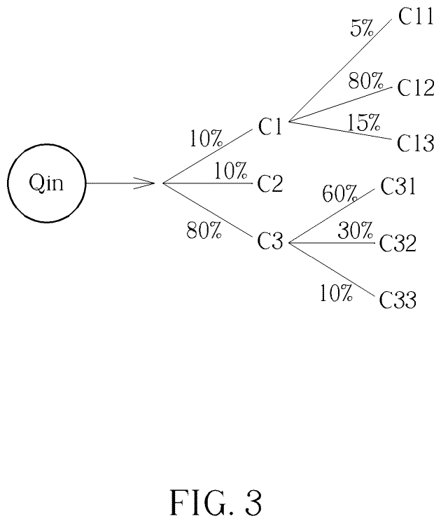

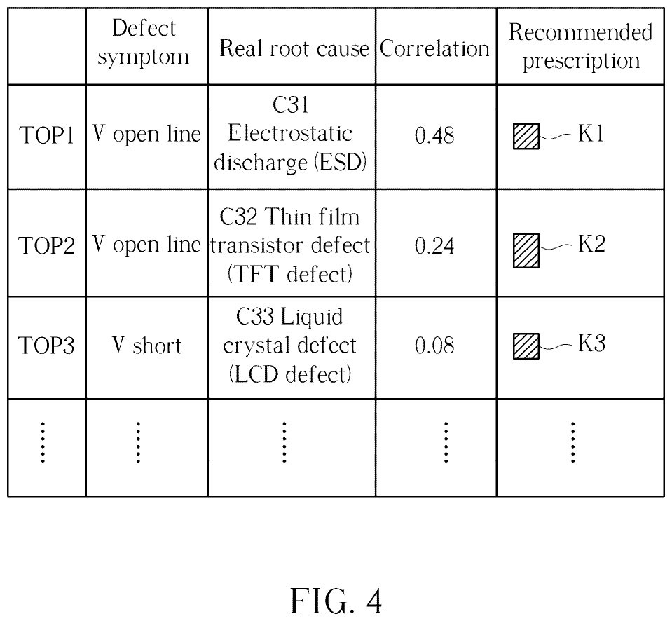

FIG. 3 and FIG. 4 are visual schematic diagrams of the plurality of the second feature values (for example, the “real root cause” of the problem) and the corresponding proportions output by the information query system 100 in FIG. 1 according to an embodiment of the present disclosure. FIG. 3 may be a dendrogram. FIG. 4 may be a list-like schematic diagram. Optionally, one of the FIG. 3 and the FIG. 4 may be output to the display unit (as shown in FIG. 1) for the user to view, or both of them may be output for the user to view. The user may set it according to the needs.

As shown in FIG. 1 to FIG. 3, when the user inputs the query request Qin, the information query system 100 may inform the user that the second feature value (for example, the “real root cause” of the problem) corresponding to the question in the query request Qin includes the cause C1, the cause C2, and the cause C3 according to the query value (for example, keyword) of the query request Qin and at least one first feature value and at least one second feature value of the database D2. In other words, the problem in query request Qin may be caused by the cause C1, the cause C2 and/or the cause C3. The corresponding proportions of the cause C1, the cause C2 and the cause C3 may be 10%, 10% and 80% respectively. Therefore, in this example, for the query request Qin, it is more likely that the cause C3 may explain and/or solve the query request Qin, but the users may still make their own judgment.

Furthermore, the information query system 100 may further analyze the deeper real root causes of the defect symptoms corresponding to the cause C1 and the cause C3. As shown in FIG. 3, the defect symptom corresponding to the cause C1 may be caused by the cause C11, the cause C12 and/or the cause C13. The corresponding proportions of the cause C11, the cause C12 and the cause C13 may be 5%, 80% and 15% respectively. The defect symptom corresponding to the cause C3 may be caused by the cause C31, the cause C32 and/or the cause C33. The corresponding proportions of the cause C31, the cause C32 and the cause C33 may be 60%, 30% and 10% respectively. Therefore, the dendrogram may be used to provide users with more and deeper clues and tips to help users debug errors. As shown in FIG. 3, the real root cause may be searched for at the next level, and the proportion corresponding to each branch add up to 100%.

FIG. 3 is a schematic diagram, according to an embodiment, each of the query request Qin and the cause C1, the cause C2, the cause C3, the cause C11, the cause C12, the cause C13, the cause C31, the cause C32 and the cause C33 in FIG. 3 may include at least one keyword or description sentences to make it easier for users to read. For example, the cause C31 may be electrostatic discharge (ESD), the cause C32 may be thin film transistor defects (TFT defects), the cause C33 may be liquid crystal defects (LCD defects), etc. to help users debug. FIG. 3 is only an example, in different situations, the dendrogram may have more branches to provide more possible causes of the problem.

FIG. 4 provides a list. In the list, defect symptoms and real root causes are sorted according to the proportions corresponding to the real root causes for easy reference by the user. The defect symptoms listed in FIG. 4 may be related defect symptoms found by the computing unit 120 in the historical data H according to the query request. In FIG. 4, the correlation of the real root cause C31 (0.48) may be the product of the proportion corresponding to the cause C3 in FIG. 3 (80%) and the proportion corresponding to the cause C31 (60%). In FIG. 4, the correlation of the real root cause C32 (0.24) may be the product of the proportion corresponding to the cause C3 in FIG. 3 (80%) and the proportion corresponding to the cause C32 (30%). In FIG. 4, the correlation (0.08) of the real root cause C33 can be the product of the proportion corresponding to the cause C3 in FIG. 3 (80%) and the proportion corresponding to the cause C33 (10%). In similar way, the various real root causes of the query request Qin in the historical data H may be sorted and listed according to the correlation for the user to view and help the user debug. In the example in FIG. 4, the cause C31 is the real root cause ranked first, but this is only for reference and users can make their own judgments.

If the historical data H may provide relevant information, in the table in FIG. 4, a “recommended prescription” field may be set and virtual buttons K2 and K3 may be set for the user to click to obtain relevant information on how to deal with the problem. The names and layout of each field in FIG. 4 are examples, and users may reasonably modify the arrangement and names of fields according to their needs.

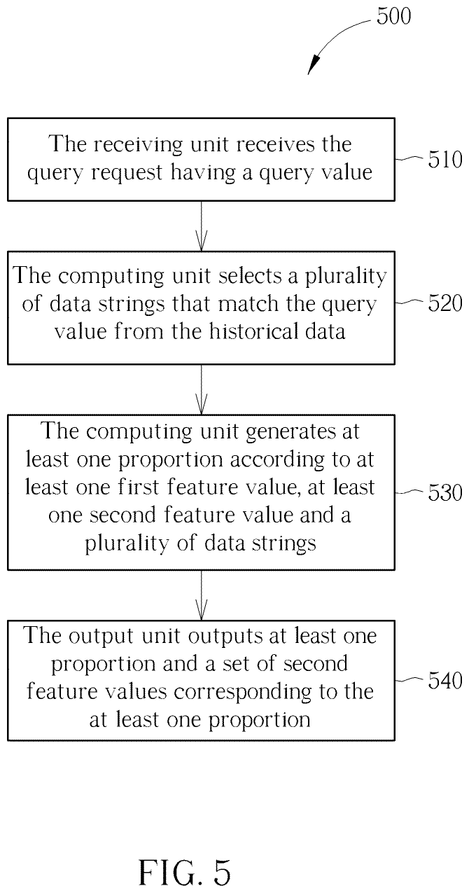

FIG. 5 is a flow chart of an information query method 500 used in the information query system 100 of FIG. 1. As shown in FIG. 1 and FIG. 5, the information query method 500 may include the following steps:
Step 510: The receiving unit 110 receives the query request Qin having a query value;
Step 520: The computing unit 120 selects a plurality of data strings that match the query value from the historical data H;
Step 530: The computing unit 120 generates at least one proportion according to at least one first feature value, at least one second feature value and a plurality of data strings;
Step 540: The output unit 130 outputs at least one proportion and a set of second feature values corresponding to the at least one proportion.

In step 520, an suitable algorithm may be used to select a plurality of data strings, and the plurality of data strings may be a plurality of documents in the historical data H. For example, suitable algorithms may include the Okapi BM25 algorithm, or other suitable algorithms. The at least one first feature value and the at least one second feature value described in Step 530 may be stored in the database D2 in FIG. 2 using a noun list database, and may be read from the database D2 in FIG. 2. The first feature value may be a defect symptom of the production line and product, and the second feature value may be the actual root cause of the defect symptom. In Step 530, the conditional probability calculation described above may be performed to generate a proportion corresponding to each second feature value. In Step 540, a set of second feature values (for example, the “real root cause” of the problem) and a corresponding set of proportions may be output for the user to view, and help the user to debug. In Step 540, the method of FIG. 3 and/or FIG. 4 may be used to output the second feature value (for example, the “real root cause” of the problem) and the corresponding proportion for easy reference by the user.

In summary, by using the information query system 100 and the information query method 500 provided by the embodiment, after the user enters a problem through the query request Qin, the user may get results such as those shown in FIG. 3 and/or FIG. 4 within minutes or even seconds. The user may know the real root cause of the problem and see the corresponding proportion. Therefore, a large amount of time for searching historical data may be saved, and clues helpful for debugging may be quickly and effectively obtained, which is of significant help to various knowledge fields such as industrial manufacturing, education, and academia.

An embodiment of the present application further provides a computer-readable storage medium on which a computer program is stored. The computer program may be used to cause a computer to execute the information query method of the above embodiments.

An embodiment of the present application further provides a computer non-volatile readable storage medium. One or more program modules may be stored in the storage medium. When one or more program modules are used on a device, they can cause the device to execute the instructions included in any of the steps of any one of the above embodiments.

The above-mentioned computer-readable storage medium may be, for example (but not limited to) an electronic, magnetic, optical, electromagnetic, infrared or semiconductor device or device, or any combination of the above. More specific examples of computer-readable storage media may include, but are not limited to, portable computer disks, hard drives, random access memory (RAM), read-only memory (ROM), erasable programmable read-only memory (EPROM), optical fiber, CD-ROM, optical memory, magnetic memory, or any suitable combination of the above.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An information query system comprising:
a receiving unit configured to receive a query request having a query value;
a computing unit configured to select a plurality of data strings that match the query value from historical data, the plurality of data strings each having a first feature value and a second feature value, the first feature value being related to the query value; and
an output unit configured to output at least one second feature value and a proportion of the at least one second feature value.

2. The information query system of claim 1, wherein the proportion of the at least one second feature value is a quotient of a first value and a second value, the second value corresponds to number of data strings comprising the first feature value in the plurality of data strings, and the first value corresponds to maximum number of data strings among the plurality of data strings having the first feature value and having a same second feature value.

3. The information query system of claim 1, wherein the proportion of the at least one second feature value is a plurality of quotient of a plurality of first values and a second value, the second value corresponds to number of data strings comprising the first feature value in the plurality of data strings, and the plurality of first values respectively correspond to number of data strings in the plurality of data strings having the first feature value and having different second feature values.

4. The information query system of claim 1, wherein the query request is transmitted to the receiving unit through an input unit.

5. The information query system of claim 1, wherein the proportion of the at least one second feature value is presented through a display unit.

6. The information query system of claim 1, wherein the historical data is stored in a cloud device.

7. The information query system of claim 1, wherein the information query system receives the historical data through a network unit.

8. The information query system of claim 1, wherein the computing unit selects the plurality of data strings that match the query value through a best matching algorithm.

9. The information query system of claim 1, wherein the computing unit selects the plurality of data strings that match the query value through an information retrieval language model method.

10. An information query method used in an information query system, wherein the information query system comprises a receiving unit, a computing unit, and an output unit, and the information query method comprising:
the receiving unit receiving a query request, the query request having a query value;
the computing unit selecting a plurality of data strings that match the query value from historical data, the plurality of data strings each comprising a first feature value and a second feature value, the first feature value being related to the query value; and
the computing unit generating at least one proportion according to at least one first feature value, at least one second feature value, and the plurality of data strings; and
the output unit outputting the at least one proportion, and the at least one second feature value corresponding to the at least one proportion.

11. The information query method of claim 10, wherein the at least one proportion is a quotient of a first value and a second value, the second value corresponds to number of data strings comprising the first feature value in the plurality of data strings, and the first value corresponds to maximum number of data strings among the plurality of data strings having the first feature value and having a same second feature value.

12. The information query method of claim 10, wherein the at least one proportion is a plurality of quotient of a plurality of first values and a second value, the second value corresponds to number of data strings comprising the first feature value in the plurality of data strings, and the plurality of first values respectively correspond to number of data strings in the plurality of data strings having the first feature value and having different second feature values.

13. The information query method of claim 10, wherein the query request is transmitted to the receiving unit through an input unit.

14. The information query method of claim 10, wherein the proportion is presented through a display unit.

15. The information query method of claim 10, wherein the historical data is stored in a cloud device.

16. The information query method of claim 10, wherein the information query system receives the historical data through a network unit.

17. The information query method of claim 10, wherein the computing unit selects the plurality of data strings that match the query value through a best matching algorithm.

18. The information query method of claim 17, wherein the best matching algorithm comprises a BM25 algorithm, a Keyword Search algorithm, an Embedding Search algorithm, and/or an Ensemble Search algorithm.

19. The information query method of claim 17, wherein the BM25 algorithm is performed to estimate a correlation between a document and the query request.

20. The information query method of claim 10, wherein the computing unit selects the plurality of data strings that match the query value through an information retrieval language model algorithm.
